(19) United States
(12) Patent Application Publication
(10) Pub. No.: US 2025/0059069 A1
(43) Pub. Date: Feb. 20, 2025

(54) Vertical Compact Flotation Unit with Air Stripping Enhanced Shallow Sedimentation Effect of Spiral Fins

(71) Applicant: Beijing Institute of Petrochemical Technology, Beijing (CN)

(72) Inventors: Jiaqing Chen, Beijing (CN); Jiayuan Zheng, Beijing (CN); Jianlong Hu, Beijing (CN); Guodong Ding, Beijing (CN); Xiaolei Cai, Beijing (CN); Yipeng Ji, Beijing (CN)

(21) Appl. No.: 18/731,467

(22) Filed: Jun. 3, 2024

(30) Foreign Application Priority Data
Aug. 18, 2023 (CN) 202311040133.7

(51) Int. Cl. C02F 1/40; B01D 17/02; C02F 101/32

(52) U.S. Cl. CPC C02F 1/40; B01D 17/0205; B01D 17/0211; B01D 17/0214; B01D 17/0217; C02F 2101/32; C02F 2201/003; C02F 2201/008; C02F 2301/022; C02F 2301/026

(57) ABSTRACT

The present disclosure provides a vertical compact flotation unit with air stripping enhanced shallow sedimentation effect of spiral fins, and relates to the technical field of complicated treatment of oily waste water such as oil field polymer flooding produced water so as to give consideration to bubble utilization rate, operation energy consumption, structure compactness and installation and maintenance cost. The equipment includes a tank, an oil receiving structure, a swirling inner cylinder, a swirl breaking structure, sedimentation separation components and a center cylinder. An exhaust port is formed in the top of the tank, a slag discharge port is formed in the bottom of the tank, the side surface of the tank is provided with an oil spill port, a water outlet pipe and a water inlet pipe, and the water inlet pipe is tangentially connected with the swirling inner cylinder.

### CROSS REFERENCE TO RELATED APPLICATION

The application claims the benefit of and takes priority from Chinese Patent Application No. 202311040133.7 filed on Aug. 18, 2023, the contents of which are herein incorporated by reference.

### TECHNICAL FIELD

The present disclosure relates to the technical field of oily waste water treatment, in particular to a vertical compact flotation unit with air stripping enhanced shallow sedimentation effect of spiral fins for polymer flooding produced water and petroleum refining waste water.

### BACKGROUND

In recent years, many oil fields have been in the development period of high water content or even ultra-high water content. In order to improve the recovery rate of oil fields, tertiary oil recovery technologies such as polymer flooding have been widely used, resulting in a large number of polymer flooding produced water that is difficult to treat. The polymer flooding produced water contains a large number of harmful substances such as petroleum hydrocarbons, sulfur and cyanide. Under the background of ecological civilization construction with increasing requirements of environmental protection, effective treatment and reinjection of polymer flooding produced water in oilfields has become an indispensable production link in current energy development. Therefore, the treatment for the produced water with compact and efficient treatment technologies becomes an urgent task in the treatment field of oilfield exploitation, especially applied in offshore oilfield produced water treatment. Limited by the limited space and bearing capacity of offshore platforms, the treatment equipment cannot be large, so that the treatment difficulty is greatly increased. Based on the compact flotation unit (CFU), air tightness, device trend, harmlessness and efficient and quick separation in the oil-water separation process of oily waste water are realized, the operating environment can be improved, the air pollution is reduced, and the recovery rate of waste oil is improved, so that the technology is of great significance for enterprises to achieve the goals of energy saving and emission reduction.

For example, the patent US2010/0187186A1 introduces a novel compact flotation unit. During the operation, oily waste water mixed with bubbles tangentially enters the inner flotation cavity to form swirling flow. The centrifugal force generated by swirling motion increases the probability of collision, contact and adhesion between bubbles released from dissolved gas water and oil droplets in waste water, and the oil droplets adhered to the bubbles continuously rise to the top of the inner flotation chamber under the action of buoyancy. Most of the oil droplets adhering to bubbles continue to float to the oil collecting hood at the upper end for enrichment, and part of oil droplets without adhering to bubbles fall along the outer flotation chamber along with the water flow. Under the action of the agglomerated layer, the particle size of the oil droplets is further increased through agglomeration, and the oil droplets adhere to microbubbles released by air dissolved water entering the outer flotation chamber tangentially, and then float to the oil collecting hood for enrichment again. After twice air flotation, the enriched oil phase overflows into the annular cavity formed between the oil collecting cap and the inner wall of the tank, and then is discharged through the oil discharge pipe. While the treated water is discharged from the water outlet. However, the agglomerated layer is prone to be blocked under actual working conditions to affect the continuous production process.

The European patent EP1400492A2 introduces a vertical induced compact flotation unit. Oily waste water enters the tank along the tangential inlet pipe and forms weak swirling flow in the tank. Under the combined action of rotational centrifugal force and air buoyancy, bubbles adhere to the oil droplets, accelerate to float up and accumulate in the oil layer, then enter the oil skimmer, and are discharged by gravity through the discharge pipe. The oil droplets without adhering to the bubbles sink with the water phase and continue to move to the center of the device under the action of swirling flow. Part of the waste water is pumped to the Venturi jet as reflux water, and air is sucked by negative pressure to produce a gas-liquid mixture. The gas-liquid mixture enters the tank through a plurality of tangential pipes to provide microbubbles needed for the air flotation, and the treated water is then discharged from the drainage pipe. However, the bubbles are not injected in advance, but are directly injected into the air flotation tank. The contact collision efficiency between bubbles and the liquid in the tank is not high, so that the subsequent separation efficiency is affected.

The US patent US2009/0294375A1 introduces a compact flotation unit. Oily waste water is uniformly distributed in the gas-liquid contact chamber through porous pipes, and gas enters the gas-liquid contact chamber through an air inlet in the top of the tank. The gas and liquid phases are fully mixed through the nozzle elbow structure to form mixed liquid with microbubbles. Under the action of the nozzle elbow, the mixed liquid is weak in swirl intensity. Bubbles and oil droplets collide and adhere in the movement process, and the adherend rises to the oil spill device on the top of the floating air treatment chamber, and finally is discharged through the oil spill pipe. However, the internal structure of the flotation tank is too complex to affect the continuous production process.

The US patent US2010/0264088A1 introduces a compact flotation unit. Saturated oily waste water enters the tank through the tangential inlet along the pipeline after being injected with air by a jet, and swirling flow is formed around the cylindrical rectifying cylinder in the tank. The centrifugal force generated by the swirling flow drives lighter components such as oil droplets and bubbles to move toward the center. During the movement, the oil droplets and bubbles continuously contact and adhere to each other, and continuously rise to the top to be aggregated into an oil layer under the action of buoyancy. Then the enriched oil is discharged through the oil discharge pipe under the pressure difference, and the escaped gas forms an air chamber at the top of the arch, and is transported to the ejector at the entrance through the exhaust pipe directly connected with the air chamber for recycling. The treated water after air flotation containing a small amount of unseparated tiny oil droplets and tiny bubbles flows through the vortex breaker to generate secondary swirling flow. A section of liquid cone with lower pressure is formed, and the agglomerated large oil droplets are convenient for the next treatment. However, the device is free of a separate sand discharge port, thus easily causing blockage in actual operation.

A pressure-type air flotation separation device is introduced by Ningbo Veritas-MSI Multiphase Flow Instrument and Equipment Co., Ltd. in the patent CN101935081A. During the operation, oily waste water containing bubbles enters the air flotation separation device in the tangential direction, and swirling flow is formed in the annular cavity between the tank and the rectifying cylinder. The bubbles are fully mixed with oil droplets, and a bubble rectification area is formed after continuous contact and adhesion. The bottom of the bubble rectification area is closed, so oily waste water mixed with microbubbles and adhered to microbubbles flows upward and enters the flotation separation area through the top of the rectification cylinder. The oil droplets adhering to the microbubbles keep floating to the water surface under the action of buoyancy, and scum is formed. The swirling direction of the scum formed in the flotation separation area is opposite to the involute convergent direction of the slag receiving deflector, so the scum enters the oil receiving cylinder under the guidance of the slag receiving deflector and then is discharged through the oil discharge pipe. The gas is discharged through the exhaust pipe at the top of the device, and the treated water is discharged from the drainage pipe at the bottom of the tank. However, objectively speaking, the occupied area of the device is large, and the compactness of the equipment needs to be further improved.

### SUMMARY

The present disclosure aims to provide a vertical compact flotation unit with air stripping enhanced shallow sedimentation effect of spiral fins so as to consider the bubble utilization rate and structure compactness of the unit. Through a preferred technical scheme in various technical schemes provided by the present disclosure, various generated technical effects are explained in detail as follow.

In order to achieve the above-mentioned purpose, the present disclosure provides the following technical scheme.

A vertical compact flotation unit with air stripping enhanced shallow sedimentation effect of spiral fins provided by the present disclosure includes a tank, a swirling inner cylinder, an oil receiving structure, a swirl breaking structure, sedimentation separation components and a center cylinder. An exhaust port is formed in the top of the tank, a slag discharge port is formed in the bottom of the tank, and the side surface of the tank is provided with an oil spill port, a water outlet pipe and a water inlet pipe. The oil spill port gets close to the top of the tank and communicates with the oil receiving structure. The water outlet pipe gets close to the bottom of the tank and is located below the center cylinder. The water inlet pipe is tangentially connected with the swirling inner cylinder. The center cylinder is vertically arranged. The sedimentation separation components are arranged on the center cylinder, and the top of the center cylinder sequentially passes through the swirl breaking structure and the swirling inner cylinder to stretch into lower oil receiving structure. The top of the swirl breaking structure communicates with the swirling inner cylinder, and the swirl breaking structure is used for destroying the swirling state of liquid and providing a laminar flow environment for a lower shallow sedimentation area. Oil receiving ports matched with the sedimentation separation components are formed in the center cylinder, and an oil phase separated by the sedimentation separation components can enter the center cylinder through the oil receiving ports so that the oil phase floats upward in the center cylinder to the oil receiving structure.

Further, the swirl breaking structure includes a shell and swirl breaking plates. A cavity is formed in the shell. The top of the shell communicates with the swirling inner cylinder. The center cylinder passes through the shell and are distributed inside the shell at intervals along the circumferential direction of the center cylinder. Discharge ports are formed in the circumferential side surface of the shell. One of the discharge ports is correspondingly formed between every two adjacent breaking plates.

Further, the swirling inner cylinder is of a structure with an upper straight cylinder and a lower conical cylinder, and the swirling inner cylinder is located at the position of the middle and upper part inside the tank.

Further, the ratio of the length of the swirl breaking plate to the diameter of the straight section of the swirling inner cylinder is 0.2-0.3, the ratio of the width of the swirl breaking plate to the diameter of the straight section of the swirling inner cylinder is 0.04-0.08, and the central angle corresponding to every two adjacent swirl breaking plates is 10°-20°.

Further, the sedimentation separation component includes a plurality of spiral fins. All the spiral fins are sequentially arranged so as to be spirally distributed on the outer side surface of the center cylinder. A gap is formed between every two adjacent spiral fins. The oil receiving ports are spirally distributed on the center cylinder.

Further, the ratio of the height of the sedimentation separation component to the total height of the tank is 0.4-0.5, the central angle of the single spiral fin is 110°-120°, and the pitch of the single spiral fin is 30 mm to 40 mm.

Further, the oil receiving structure includes a bottom plate part and a side plate part. The bottom plate part is annular, and the outer circumferential side edge of the bottom plate part is connected with the inner side surface of the tank. The inner side edge of the bottom plate part is connected with the side plate part. An annular oil receiving tank is formed among the bottom plate part. The side plate part and the inner side surface of the tank. The diameter of the side plate part is larger than that of the swirling inner cylinder.

Further, water outlet holes are formed in the side plate part, the water outlet holes are arranged along the circumferential direction of the side plate part, and the water outlet holes get close to the bottom of the side plate part. The top edge of the side plate part is provided with sawteeth.

Further, the vertical compact flotation unit also includes an air supply pipe. The air supply pipe is inserted into the tank and one end of the air supply pipe is located at the bottom of the center cylinder. A flared structure is arranged at the bottom of the center cylinder.

Further, the flared structure is coaxially and fixedly connected with the center cylinder, the height of the flared structure is 20 mm to 30 mm, and the inclination angle of the generatrix of the flared structure is 60°-70°.

The preferred technical scheme of the present disclosure may generate one of the following technical effects.

According to the vertical compact flotation unit with air stripping enhanced shallow sedimentation effect of spiral fins provided by the present disclosure, the structure is compact, cooperative enhanced separation is carried out through the swirling inner cylinder and the sedimentation separation components, the oil-water separation effect is good, and the bubble utilization rate is high.

The swirl breaking area consisting of the swirl breaking plates provides a stable flow field for the lower shallow sedimentation area for spiral fins while formed swirling flow is reserved in the whirling inner cylinder.

Through the design of spiral fins, the gravity separation process after oil droplets are agglomerated is strengthened by the shallow sedimentation area, and the distribution of fins can reduce the accumulation of suspended solids on the fins in oily waste water.

The oil phase in the shallow sedimentation area outside the center cylinder is promoted to be aggregated inside the center cylinder through the oil inlet of the center cylinder by adding the air supply pipe for supplying air. The circulation of the phase medium between the fins and the center cylinder is accelerated by air stripping effect, so that the oily waste water is prevented from directly flowing in the lower part from both sides of the fins to form short-circuit flow. At the same time, the flared structure is added above the air supply pipe, so that large bubbles can be effectively prevented from scattering.

According to the vertical compact flotation unit with air stripping enhanced shallow sedimentation effect of spiral fins provided by the present disclosure, based on the concept of structure compactness and unit technology compounding, the present disclosure provides a vertical compact flotation unit for carrying out cooperative enhanced separation by means of internal rotation of an inner cylinder, spiral fins and an additional air supply pipe. On one hand, the weak swirl field and swirl state are kept stable by the swirling inner cylinder with an upper straight cylinder and a lower conical cylinder, so that large bubbles capable of destroying flotation can be separated, and small bubbles that are helpful to the flotation process are reserved. On the other hand, the gravity separation process after oil droplets are agglomerated is strengthened by the sedimentation separation area, so that the collision and adhesion between oil droplets and bubbles are further promoted. In addition, by arranging the swirl breaking structure, the laminar flow environment is provided for the oil-water separation process in the shallow sedimentation area, so that the oil-water separation process is further strengthened.

### BRIEF DESCRIPTION OF THE DRAWINGS

To describe the technical solutions in the embodiments of the present disclosure or in the prior art more clearly, the following briefly describes the attached figures required for describing the embodiments or the prior art. Apparently, the attached figures in the following description show merely some embodiments of the present disclosure, and a person of ordinary skill in the art may derive other drawings from these attached figures without creative efforts.

FIG. 1 is a structural schematic diagram of a vertical compact flotation unit provided by the present disclosure.

FIG. 2 is a longitudinal section view of a vertical compact flotation unit provided by the present disclosure.

FIG. 3 is a structural schematic diagram of a swirl breaking structure inside a tank provided in the present disclosure.

FIG. 4 is a transverse section view of a vertical compact flotation unit provided by the present disclosure.

FIG. 5 is a structural schematic diagram of a sedimentation separation component provided in the present disclosure.

Reference signs: 1, tank; 2, swirling inner cylinder; 3, oil spill port; 4, oil receiving structure; 401, bottom plate part; 402, side plate part; 403, annular oil receiving tank; 404, sawtooth; 5, exhaust port; 6, water outlet hole; 7, water inlet pipe; 8, swirl breaking structure; 801, shell; 802, swirl breaking plate; 803, discharge port; 9, sedimentation separation component; 901, spiral fin; 10, flared structure; 11, water outlet pipe; 12, oil receiving port; 13, center cylinder; 14, air supply pipe; and 15, slag discharge port.

### DETAILED DESCRIPTION OF THE EMBODIMENTS

In order to make the purpose, technical scheme and advantages of the present disclosure more clear, the technical scheme of the present disclosure is described in detail as follows. Apparently, the embodiments in the following description are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

The present disclosure provides a vertical compact flotation unit, including a tank 1, a swirling inner cylinder 2, an oil receiving structure 4, a swirl breaking structure 8, sedimentation separation components 9 and a center cylinder 13. An exhaust port 5 is formed in the top of the tank 1, a slag discharge port 15 is formed in the bottom of the tank 1, and the side surface of the tank 1 is provided with an oil spill port 3, a water outlet pipe 11 and a water inlet pipe 7. The oil spill port 3 gets close to the top of the tank 1 and communicates with the oil receiving structure 4. The water outlet pipe 11 gets close to the bottom of the tank 1 and is located below the center cylinder 13. The water inlet pipe 7 is tangentially connected with the swirling inner cylinder 2. The center cylinder 13 is vertically arranged. The sedimentation separation components 9 are arranged on the center cylinder 13. The top of the center cylinder 13 sequentially passes through the swirl breaking structure 8 and the swirling inner cylinder 2 to stretch into lower oil receiving structure 4. The top of the swirl breaking structure 8 communicates with the swirling inner cylinder 2, and the swirl breaking structure 8 is used for destroying the swirling state of liquid and providing a laminar flow environment for a lower shallow sedimentation area. Oil receiving ports 12 matched with the sedimentation separation components 9 are formed in the center cylinder 13, and an oil phase separated by the sedimentation separation components 9 can enter the center cylinder 13 through the oil receiving ports 12 so that the oil phase floats upward in the center cylinder 13 to the oil receiving structure 4.

Oily waste water mixed with fine bubbles enters the swirling inner cylinder 2 from the tangential water inlet pipe 7 at the upper part of the equipment, and the oily waste water generates a weak swirling flow field in the swirling inner cylinder 2, so that the collision and adhesion probability between fine bubbles and dispersed phase oil droplets is effectively increased, large bubbles capable of destroying flotation are separated, and small bubbles beneficial to the flotation process are reserved. An annular gap is formed between an upper end of the swirling inner cylinder 2 and the center cylinder 13, and gas and a small amount of oil phase move upward through the annular gap and enter the oil receiving structure 4. A swirl breaking area consisting of the swirl breaking structure 8 is arranged below the swirling inner cylinder 2, and a fluid in the swirling inner cylinder 2 flows to the sedimentation separation components 9 through the swirl breaking structure 8. The swirl breaking structure 8 provides a stable flow field for the lower sedimentation separation components 9 while formed swirling flow is reserved in the whirling inner cylinder. Most of oil-water mixture flows to the sedimentation separation components 9 through the swirl breaking structure 8, an area is formed in the tank 1 at the position of the sedimentation separation components 9, and the gravity separation after the oil droplets are agglomerated is strengthened by the sedimentation separation components 9. Oil receiving ports 12 are formed in the center cylinder 13 of the shallow sedimentation area, and the oil phase after sedimentation separation collides with and adheres to the fine bubbles again, and then floats up to the oil receiving structure 4 through the oil receiving ports 12. Oil in the oil receiving structure 4 can be discharged through the oil spill port 3, and a gas phase is collected on the top of the tank 1 and discharged through the exhaust port 4. Finally, purified waste water is discharged through the lower water outlet pipe 11, and impurities such as solid suspended matters are discharged through the bottom slag discharge port 15.

According to the vertical compact flotation unit with air stripping enhanced shallow sedimentation effect of spiral fins provided by the present disclosure, the structure is compact. The separation of the mixture is enhanced cooperatively through the swirling inner cylinder and the sedimentation separation components. The oil-water separation effect is good, and the bubble utilization rate is high.

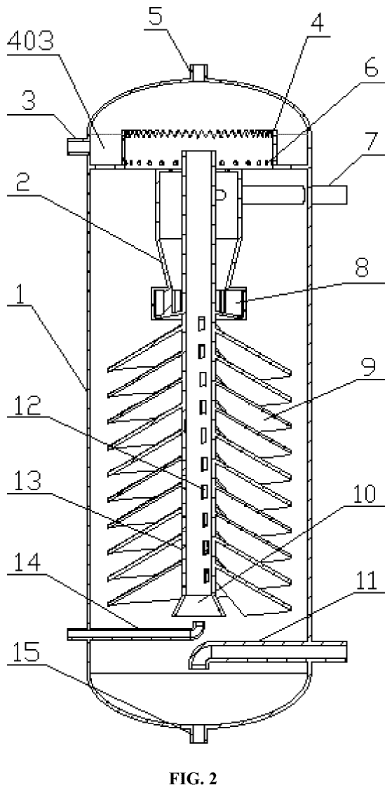

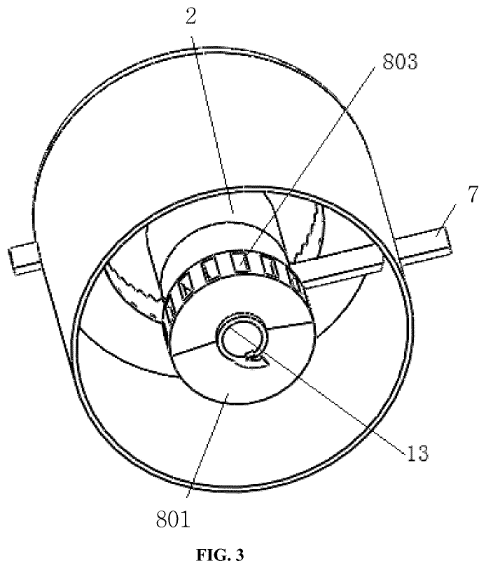

With respect to the swirl breaking structure 8, the specific structure of the swirl breaking structure 8 is as follows. Referring to FIG. 2 to FIG. 4, the swirl breaking structure 8 includes a shell 801 and swirl breaking plates 802. A cavity is formed in the shell 801. The top of the shell 801 communicates with the swirling inner cylinder 2. The center cylinder 13 passes through the shell 801 and are distributed inside the shell 801 at intervals along the circumferential direction of the center cylinder 13. Discharge ports 803 are formed in the circumferential side surface of the shell 801, and one of the discharge port 803 is correspondingly formed between every two adjacent breaking plates 802.

Referring to FIG. 2 to FIG. 4, an upper opening is formed in the top of the shell 801. The swirling inner cylinder 2 is inserted into the upper opening, and the outer side wall of the swirling inner cylinder 2 is connected with the upper opening. A lower opening is formed in the bottom of the shell 801, the center cylinder 13 passes through the lower opening of the shell 801, and the circumferential side surface of the center cylinder 13 is connected with the lower opening.

Discharge ports 803 are formed in the circumferential side surface of the shell 801, and a fluid entering the swirl breaking structure 8 from the swirling inner cylinder 2 can be discharged through the discharge ports 803.

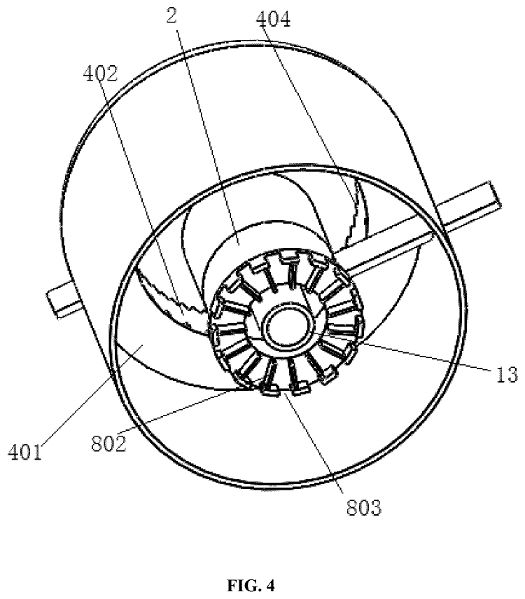

Referring to FIG. 4, the swirl breaking plates 802 uniformly distributed at intervals along the circumferential direction are schematically shown. One of the discharge port 803 is correspondingly formed between every two adjacent breaking plates 802.

Referring to FIG. 4, one end, away from the center cylinder 13, of the swirl breaking plate 802 is connected with the circumferential inner side surface of the shell 801 or a gap is formed. One end, close to the center cylinder, of the swirl breaking plate 802 is basically flush with the upper opening in the top of the shell 801 along the axis direction.

With respect to the structure of the swirling inner cylinder 2, the swirling inner cylinder 2 is of a structure with an upper straight cylinder and a lower conical cylinder, and the swirling inner cylinder 2 is located at the position of the middle and upper part inside the tank 1. Through the design of the swirling inner cylinder 2 with an upper straight cylinder and a lower conical cylinder, the weak swirling flow field and the swirling flow state are kept stable. The oily waste water is swirled in the swirling inner cylinder 2, so that the collision and adhesion probability between fine bubbles and dispersed phase oil droplets is effectively increased, large bubbles capable of destroying flotation can be separated, and small bubbles that are helpful to flotation process are reserved for preliminary preseparation.

The axes of the swirling inner cylinder 2 and the center cylinder 13 are collinear with the vertical central axis of the tank 1. The center cylinder 13 passes through the swirling inner cylinder 2 and a gap is formed between the center cylinder 13 and the swirling inner cylinder 2. The ratio of the diameter of the center cylinder 13 to the diameter of the swirling inner cylinder 2 is 0.3-0.5.

With respect to the size of the swirl breaking plate 802, preferably, the ratio of the length of the swirl breaking plate 802 to the diameter of the straight section of the swirling inner cylinder 2 is 0.2-0.3. The ratio of the width of the swirl breaking plate 802 to the diameter of the straight section of the swirling inner cylinder 2 is 0.04-0.08, and the ratio of the width of the swirl breaking plate 802 to the diameter of the straight section of the swirling inner cylinder 2 is preferably 0.05. The central angle corresponding to every two adjacent swirl breaking plates 802 is 10°-20°, and the central angle corresponding to every two adjacent swirl breaking plates 802 is preferably 12°.

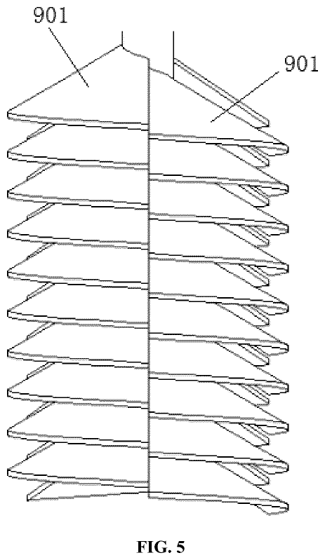

With respect to the specific structure of the sedimentation separation component 9, referring to FIG. 2 and FIG. 5, the sedimentation separation component 9 includes a plurality of spiral fins 901. All the spiral fins 901 are sequentially arranged so as to be spirally distributed on the outer side surface of the center cylinder 13. A gap is formed between every two adjacent spiral fins 901. The oil receiving ports 12 are spirally distributed on the center cylinder 13. Referring to FIG. 2, the oil receiving port 12 is formed between the spiral fins 901. The ratio of the length of the oil receiving port 12 to the spacing of fins is 0.45 to 0.75.

The ratio of the height of the sedimentation separation component 9 to the total height of the tank 1 is 0.4-0.5. The central angle of the single spiral fin 901 is 110°-120°, preferably 120°. The pitch of the single spiral fin 901 is 30 mm to 40 mm, preferably 32 mm.

With regard to the oil receiving structure 4, referring to FIG. 2 and FIG. 4, the oil receiving structure 4 includes a bottom plate part 401 and a side plate part 402. The bottom plate part 401 is annular, and the outer circumferential side edge of the bottom plate part 401 is connected with the inner side surface of the tank 1. The inner side edge of the bottom plate part 401 is connected with the side plate part 402. An annular oil receiving tank 403 is formed among the bottom plate part 401, the side plate part 402 and the inner side surface of the tank 1. The diameter of the side plate part 402 is larger than that of the swirling inner cylinder 2. Referring to FIG. 2, the positional relationship between the top of the center cylinder 13 and the side plate part 402 is schematically shown.

Preferably, water outlet holes 6 are formed in the side plate part 402. The water outlet holes 6 are arranged along the circumferential direction of the side plate part 402. The water outlet holes 6 get close to the bottom of the side plate part 402. An extremely small amount of water phase is discharged through the water outlet holes 6 inside the annular oil receiving tank 403. The top edge of the side plate part 402 is provided with sawteeth 404.

The vertical compact flotation unit also includes an air supply pipe 14. The air supply pipe 14 is inserted into the tank 1, and one end of the air supply pipe 14 is located at the bottom of the center cylinder 13. A flared structure 10 is arranged at the bottom of the center cylinder 13. The flared structure 10 can effectively prevent the large bubbles from scattering. The oil phase in the shallow sedimentation area outside the center cylinder is promoted to be aggregated inside the center cylinder by adding the air supply pipe for supplying air.

With respect to the flared structure 10, the flared structure 10 is coaxially and fixedly connected with the center cylinder 13. The height of the flared structure 10 is 20 mm to 30 mm. The inclination angle of the generatrix of the flared structure 10 is 60°-70°, preferably 65°.

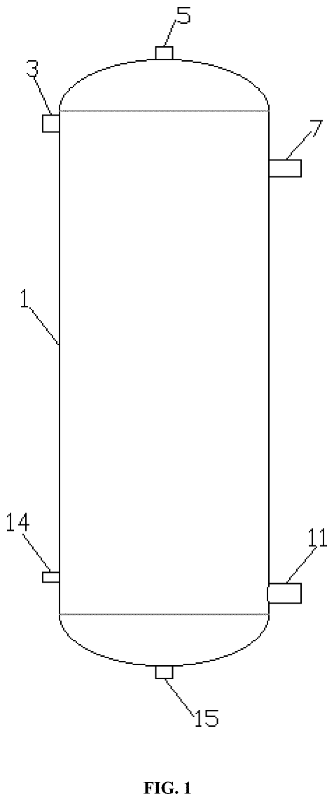

Combined with the vertical compact flotation unit schematically shown in FIG. 1 to FIG. 5, the separation process of the s oily waste water is specifically as follows.

Oily waste water mixed with fine bubbles enters the swirling inner cylinder 2 with an upper straight cylinder and a lower conical cylinder from the tangential water inlet pipe 7 at the upper part of the equipment. Through the design with an upper straight cylinder and a lower conical cylinder, the weak swirling flow field and the swirling flow state are kept stable. Large bubbles capable of destroying flotation are separated, and small bubbles beneficial to the flotation process are reserved. An annular gap is formed between an upper end of the swirling inner cylinder 2 and the center cylinder 13, and gas and a small amount of oil phase move upward through the annular gap and enter the oil receiving tank 403. A swirl breaking area consisting of the swirl breaking structure 8 is arranged below the swirling inner cylinder 2. The swirl breaking plates 802 are distributed in the swirl breaking area at intervals. The swirl breaking structure 8 provides a stable flow field for the lower shallow sedimentation area for spiral fins while formed swirling flow is reserved in the whirling inner cylinder. The sedimentation separation components 9 are fixedly installed on the lower side of the swirl breaking area, and most of the oil-water mixture flows out along the discharge ports 803 of the swirl breaking structure 8, and then the gravity separation after oil droplets are agglomerated is enhanced through the shallow sedimentation area for fins. Oil receiving ports 12 of the center cylinder arranged correspondingly to the fins are formed in the center cylinder 13 of the sedimentation area, and the oil phase after sedimentation separation collides with and adheres to the fine bubbles again, and then floats up to the annular oil tank 403, so that oil-water separation is completed again. An extremely small amount of water phase in the annular oil receiving tank 403 is discharged through the water outlet holes 6. In addition, large bubbles are pumped through the air supply pipe 14 below the center cylinder 13 with spiral fins. The oil phase in the shallow sedimentation area outside the center cylinder is promoted to be aggregated inside the center cylinder through the oil inlet of the center cylinder. The circulation of the phase medium between the fins and the center cylinder is accelerated by air stripping effect, so that the oily waste water is prevented from directly flowing in the lower part from both sides of the fins to form short-circuit flow (the sedimentation separation component 9 is of a discontinuous and non-integrated spiral structure, so that incoming liquid can flow into the sedimentation separation components, and it is not easy to cause the fluid to directly flow to the bottom of the tank 1 along the both sides of the spiral fins to form short-circuit flow). At the same time, the flared structure is added above the air supply pipe, so that large bubbles can be effectively prevented from scattering.

In addition, a connecting fixed structure is not schematically shown in FIG. 2, namely a structure for fixing the parts in the tank 1 inside the tank 1 is not schematically shown.

Based on the concept of structure compactness and unit technology compounding, the present disclosure provides a vertical compact flotation unit for carrying out cooperative enhanced separation by means of internal rotation of an inner cylinder, spiral fins and an additional air supply pipe.

In the description of the present disclosure, it needs to be illustrated that, except as otherwise noted, the meaning of “a plurality of” is two or more than two; and the indicative direction or position relations of the terms such as “upper”, “lower”, “left”, “right”, “inside”, “outside”, “front end”, “rear end”, “head” and “tail” are direction or position relations illustrated based on the accompanying diagrams, just for facilitating the description of the present disclosure and simplifying the description, but not for indicating or hinting that the indicated device or element must be in a specific direction and is constructed and operated in the specific direction, the terms cannot be understood as the restriction of the present disclosure. Moreover, the terms such as “first”, “second”, and “third” are just used for distinguishing the description, but cannot be understood to indicate or hint relative importance.

In the description of the present disclosure, it further needs to be illustrated that, except as otherwise noted, the terms such as “mount”, “link” and “connect” should be generally understood. For example, the components can be fixedly connected, and also can be detachably connected or integrally connected; the components can be mechanically connected, and also can be electrically connected; and the components can be directly connected, and also can be indirectly connected through an intermediate. For those skilled in the art, the specific meanings of the terms in the present disclosure can be understood according to specific conditions.

In the description of the specification, the description of the reference terms such as “one embodiment”, “some embodiments”, “examples”, “specific examples” or “one example” indicates to be contained in at least one embodiment or example of the disclosure in combination with specific characteristics, structures, materials or characteristics described by the embodiment or example. In the specification, schematic expression of the above terms does not necessarily refer to the same embodiment or example. Moreover, the described specific features, structures, materials or characteristics can be combined in any of one or more embodiments or examples appropriately.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A vertical compact flotation unit with air stripping enhanced shallow sedimentation effect of spiral fins, comprising a tank (1), a swirling inner cylinder (2), an oil receiving structure (4), a swirl breaking structure (8), sedimentation separation components (9) and a center cylinder (13), wherein
an exhaust port (5) is formed in the top of the tank (1), a slag discharge port (15) is formed in the bottom of the tank (1), the side surface of the tank (1) is provided with an oil spill port (3), a water outlet pipe (11) and a water inlet pipe (7), the oil spill port (3) gets close to the top of the tank (1) and communicates with the oil receiving structure (4), the water outlet pipe (11) gets close to the bottom of the tank (1) and is located below the center cylinder (13), and the water inlet pipe (7) is tangentially connected with the swirling inner cylinder (2);
the center cylinder (13) is vertically arranged, the sedimentation separation components (9) are arranged on the center cylinder (13), and the top of the center cylinder (13) sequentially passes through the swirl breaking structure (8) and the swirling inner cylinder (2) to stretch into lower oil receiving structure (4);
the top of the swirl breaking structure (8) communicates with the swirling inner cylinder (2), and the swirl breaking structure (8) is used for destroying the swirling state of liquid and providing a laminar flow environment for a lower shallow sedimentation area;
oil receiving ports (12) matched with the sedimentation separation components (9) are formed in the center cylinder (13), and an oil phase separated by the sedimentation separation components (9) can enter the center cylinder (13) through the oil receiving ports (12) so that the oil phase floats upward in the center cylinder (13) to the oil receiving structure (4).

2. The vertical compact flotation unit with air stripping enhanced shallow sedimentation effect of spiral fins according to claim 1, wherein the swirl breaking structure (8) comprises a shell (801) and swirl breaking plates (802), a cavity is formed in the shell (801), the top of the shell (801) communicates with the swirling inner cylinder (2), the center cylinder (13) passes through the shell (801) and are distributed inside the shell (801) at intervals along the circumferential direction of the center cylinder (13), discharge ports (803) are formed in the circumferential side surface of the shell (801), and one of the discharge ports (803) is correspondingly formed between every two adjacent breaking plates (802).

3. The vertical compact flotation unit with air stripping enhanced shallow sedimentation effect of spiral fins according to claim 2, wherein the swirling inner cylinder (2) is of a structure with an upper straight cylinder and a lower conical cylinder, and the swirling inner cylinder (2) is located at the position of the middle and upper part inside the tank (1).

4. The vertical compact flotation unit with air stripping enhanced shallow sedimentation effect of spiral fins according to claim 3, wherein the ratio of the length of the swirl breaking plate (802) to the diameter of the straight section of the swirling inner cylinder (2) is 0.2-0.3, the ratio of the width of the swirl breaking plate (802) to the diameter of the straight section of the swirling inner cylinder (2) is 0.04-0.08, and the central angle corresponding to every two adjacent swirl breaking plates (802) is 10°-20°.

5. The vertical compact flotation unit with air stripping enhanced shallow sedimentation effect of spiral fins according to claim 1, wherein the sedimentation separation component (9) comprises a plurality of spiral fins (901), all the spiral fins (901) are sequentially arranged so as to be spirally distributed on the outer side surface of the center cylinder (13), a gap is formed between every two adjacent spiral fins (901), and the oil receiving ports (12) are spirally distributed on the center cylinder (13).

6. The vertical compact flotation unit with air stripping enhanced shallow sedimentation effect of spiral fins according to claim 5, wherein the ratio of the height of the sedimentation separation component (9) to the total height of the tank (1) is 0.4-0.5, the central angle of the single spiral fin (901) is 110°-120°, and the pitch of the single spiral fin (901) is 30 mm to 40 mm.

7. The vertical compact flotation unit with air stripping enhanced shallow sedimentation effect of spiral fins according to claim 1, wherein the oil receiving structure (4) comprises a bottom plate part (401) and a side plate part (402), the bottom plate part (401) is annular, the outer circumferential side edge of the bottom plate part (401) is connected with the inner side surface of the tank (1), the inner side edge of the bottom plate part (401) is connected with the side plate part (402), an annular oil receiving tank (403) is formed among the bottom plate part (401), the side plate part (402) and the inner side surface of the tank (1), and the diameter of the side plate part (402) is larger than that of the swirling inner cylinder (2).

8. The vertical compact flotation unit with air stripping enhanced shallow sedimentation effect of spiral fins according to claim 7, wherein water outlet holes (6) are formed in the side plate part (402), the water outlet holes (6) are arranged along the circumferential direction of the side plate part (402), and the water outlet holes (6) get close to the bottom of the side plate part (402); and the top edge of the side plate part (402) is provided with sawteeth (404).

9. The vertical compact flotation unit with air stripping enhanced shallow sedimentation effect of spiral fins according to claim 1, wherein the vertical compact flotation unit also comprises an air supply pipe (14), the air supply pipe (14) is inserted into the tank (1), and one end of the air supply pipe (14) is located at the bottom of the center cylinder (13); and
a flared structure (10) is arranged at the bottom of the center cylinder (13).

10. The vertical compact flotation unit with air stripping enhanced shallow sedimentation effect of spiral fins according to claim 9, wherein the flared structure (10) is coaxially and fixedly connected with the center cylinder (13), the height of the flared structure (10) is 20 mm to 30 mm, and the inclination angle of the generatrix of the flared structure (10) is 60°-70°.
